(19) United States
(12) Patent Application Publication
(10) Pub. No.: US 2020/0391715 A1
(43) Pub. Date: Dec. 17, 2020

(54) ACOUSTIC SYSTEM AND METHOD FOR TRACTION AND BRAKING CONTROL OF A TRAIN

(71) Applicant: FAIVELEY TRANSPORT ITALIA S.p.A., Piossasco (Torino) (IT)

(72) Inventor: Roberto TIONE, Lauriano (Torino) (IT)

(21) Appl. No.: 16/618,436

(22) PCT Filed: May 28, 2018
(86) PCT No.: PCT/IB2018/053774

§ 371 Date: Dec. 2, 2019

(30) Foreign Application Priority Data
May 30, 2017 (IT) 102017000058879

(51) Int. Cl. B60T 13/66; B61H 13/34; H04B 11/00

(52) U.S. Cl. CPC B60T 13/665; B61H 13/34; B60T 2270/82; B60T 2270/402; H04B 11/00

(57) ABSTRACT

An acoustic traction and braking control system includes a modulator device associated with a master vehicle, which receives a traction or braking request signal and generates an electrical signal which is transformed into an acoustic signal to be transmitted in a brake pipe; the frequency of the acoustic signal is being adjusted according to the amplitude of the traction or braking request signal, according to a trans-characteristic function;
a transducer device, associated with a slave vehicle, which detects the acoustic signal and converts the instantaneous amplitude value thereof into an electrical signal the frequency value of which is adjusted according to the frequency of the acoustic signal; and
a frequency demodulator associated with a slave vehicle, which generates a traction or braking management signal the amplitude of which is regulated according to the frequency of the electrical signal and transmitted to a traction and braking management system associated with the at least one slave vehicle.

### CROSS-REFERENCE TO RELATED APPLICATIONS

This application is a National Phase filing of PCT International Application No. PCT/IB2018/053774, having an International Filing Date of May 28, 2018, claiming priority to Italian Patent Application No. 102017000058879, having a filing date of May 30, 2017 each of which is hereby incorporated by reference in its entirety.

### FIELD OF THE INVENTION

The present invention relates to control systems of trains, particularly for transport of goods and comprising a plurality of locomotives.

In particular, the invention relates to an acoustic system and method for traction and braking control of a train.

### BACKGROUND OF THE INVENTION

The “Distributed Power” technique born in the American “AAR” railway world is well known in the art. Such technique consists in distributing several locomotives along a train of exceptional length and weight, as shown in FIG. 1. The locomotives distributed along the train are synchronized with each other by means of a radio control system. The first locomotive is called the master locomotive and replicates the traction or braking commands to the subsequent locomotives, called the slave locomotives, by means of said radio control system (not illustrated in FIG. 1).

The purpose of the “Distributed Power” system is to better distribute traction and braking forces along the train, significantly reducing longitudinal forces that could trigger processes of derailment.

An accurate description of the distributed power system and its benefits is contained in WO2017025895, where the drawbacks of possible faults in the radio control system are also fully described and corrective solutions are claimed for operating the train in degraded conditions.

According to the report I00-002 “Sonar Transmission through the Train Brake System”, Hans Sandholt, Bengt Schmidtbauer, reporting the results of tests carried out in collaboration between the Swedish institute CHARMEC and the company SAB-WABCO Italia, today Faiveley Transport Italia, it is possible to transmit waves at subsonic frequencies along the brake line of a train up to 1.5 km long, at a maximum frequency between 5 Hz and 10 Hz. FIG. 2 shows the Bode diagram of the amplitudes as the frequency varies for various train lengths, measured on a real system: for lengths less than 30 m (curve “a” in FIG. 2), the usable band extends to frequencies on the order of tens of Hz, while for lengths greater than 1000 m, the attenuation knee occurs already at 5 Hz.

US2002153765 claims propagation of negative and positive pressure pulses along the brake line of a railway train to transmit traction or braking commands. According to such method, it is not possible to continuously modulate traction or braking commands.

### SUMMARY OF THE INVENTION

An object of the present invention is therefore to propose an acoustic system and method for the continuous traction and braking control of a train that allows an additional way of controlling a train.

The solution of the present disclosure consists in a further method, with respect to those already reported in WO2017025895, for controlling a train adopting Distributed Power technology, in the event of a fault in the radio control system.

The solution claimed herein uses the propagation of acoustic waves inside the general pipe.

Such result is obtained by means of an acoustic system for the traction and braking control of a train comprising a general brake pipe, a master vehicle comprising traction and braking devices, and at least one slave vehicle comprising traction and braking devices.

The acoustic system for the traction and braking control of a train includes:
a modulator device, associated with the master vehicle, which receives at least one traction or braking request signal and generates an electrical signal able to excite an actuator which transforms said electrical signal into a respective acoustic signal to be sent inside the general brake pipe; the frequency value of the acoustic signal being adjusted as a function of the amplitude value of the at least one traction or braking request signal, according to a predetermined trans-characteristic function;
at least one transducer device associated with at least one slave vehicle, which detects the acoustic signal and converts the instantaneous amplitude value of the acoustic signal into an electrical signal the frequency value of which is adjusted according to the frequency of the acoustic signal;
at least one frequency demodulator associated with said at least one slave vehicle, which generates a traction or braking management signal the amplitude value of which is adjusted according to the frequency of the electrical signal, the traction or braking management signal being transmitted by the frequency demodulator to a traction and braking management system associated with said at least one slave vehicle, provided for traction and braking management.

The aforesaid and other objects and advantages are achieved, according to an aspect of the present invention, by an acoustic system and method as described and claimed herein. Preferential embodiments of the invention are also described defined in the dependent claims.

The functional and structural characteristics of some preferred embodiments of an acoustic traction and braking control system according to the present invention will now be described with reference to the drawings.

### BRIEF DESCRIPTION OF THE DRAWINGS

FIG. 1 schematically illustrates a train having a plurality of vehicles, including a master vehicle and a slave vehicle;

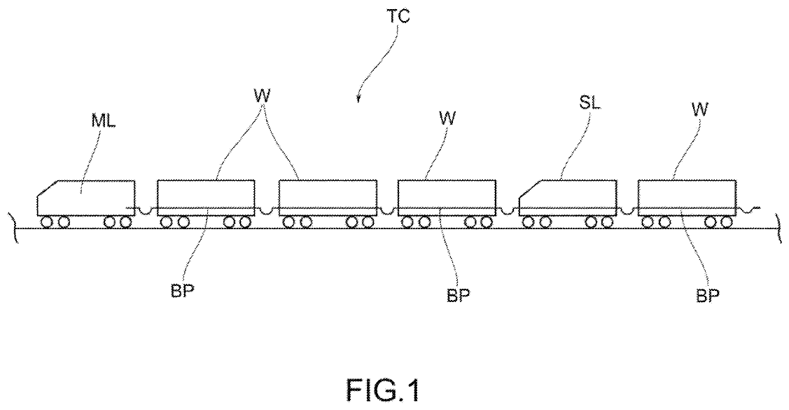

FIG. 2 illustrates a Bode diagram of the amplitudes as the frequency changes, as a function of various train lengths, measured on a real system;

FIG. 3 schematically illustrates an acoustic traction/braking control system according to the invention;

FIG. 4a illustrates a first example of modulation; and

FIG. 4b illustrates a second example of modulation.

### DETAILED DESCRIPTION OF PREFERRED EMBODIMENTS

Before describing in detail a plurality of embodiments of the invention, it should be clarified that the invention is not limited in its application to the details of construction or to the configuration of the components provided in the following description or illustrated in the drawings. The invention may assume other embodiments and may be implemented or achieved in essentially different ways. It should also be understood that the phraseology and terminology have descriptive purposes and should not be construed as limiting. The use of “include” and “comprise” and their variations are to be understood as encompassing the elements stated hereinafter and the equivalents thereof, as well as additional elements and the equivalents thereof.

The present invention describes methodologies for the modulation of subsonic waves superposed at the pressure for transmitting information related to traction and braking commands along the brake line of a train.

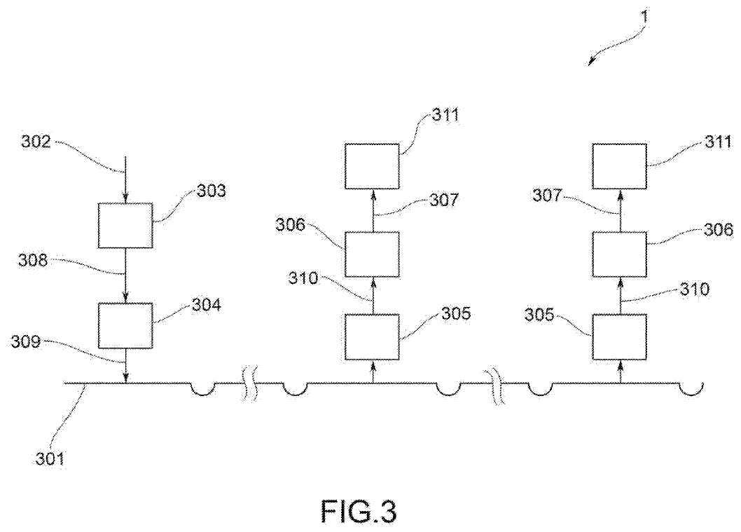

Referring initially to FIG. 3, an acoustic traction and braking control system for a train TC is illustrated, which includes a general brake line 301 and a master vehicle ML, which comprises traction and braking devices, and at least one slave vehicle SL, which comprises traction and braking devices.

The acoustic system for traction-braking transmission control 1 includes a modulator device 303 associated with the master vehicle ML. The modulator device 303 receives at least one traction or braking request signal 302 and generates an electrical signal 308 adapted to energize an actuator 304. The actuator 304 transforms said electrical signal 308 into a respective acoustic signal 309 to be transmitted inside said general brake pipe 301.

In other words, the modulator device 303 receives information to be transmitted and performs a suitable modulation thereof, as described hereinafter, subsequently driving an actuator 304 which transforms the electrical signal 308 into an acoustic signal 309. The acoustic signal 309 is then propagated along the brake pipe 301.

For example, the traction or braking request signals 302 may be generated by means of traction and braking commands given by an engine driver by means of a special command lever or by automatic traction or braking systems.

The frequency value of said acoustic signal 309 is adjusted according to the amplitude value of the traction or braking request signal 302, in accordance with a predetermined trans-characteristic function.

For example, but not necessarily, the curve of the trans-characteristic function presents a non-linear trend within the existence range thereof.

The acoustic traction and braking control system 1 according to the present invention further comprises at least one transducer device 305, associated with said at least one slave vehicle SL, which detects the acoustic signal 309 and converts the instantaneous amplitude value of the acoustic signal 309 into an electrical signal 310 the frequency value of which is adjusted according to the frequency of the acoustic signal 309.

For example, the frequency of the electrical signal 310 coincides with the frequency of the acoustic signal 309.

Moreover, said acoustic traction and braking control system 1 includes at least one frequency demodulator 306 associated with said at least one slave vehicle SL, which generates a traction or braking management signal 307 the amplitude value of which is adjusted according to the frequency of the electrical signal 310. The traction or braking management signal 307 is transmitted by the frequency demodulator 306 to a traction and braking management system 311, associated with said at least one slave vehicle SL, for the management of traction and braking.

In other words, the transducer device 305, installed on one or more slave vehicles SL, may be an acoustic/electric transducer 305 arranged along said brake pipe 301 which transforms the acoustic signal received into an electrical signal 310 for frequency demodulators 306 charged with reconstructing the initial information and providing said information to a traction/braking management system 311.

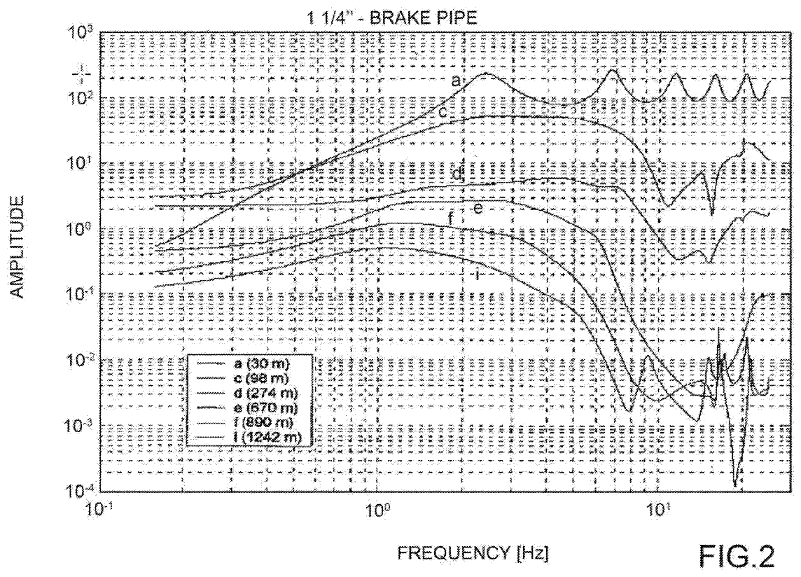

If one intends to transmit information through the entire train, it is appropriate to use subsonic frequencies, as indicated in the cases “e”, “f”, “i” of FIG. 2.

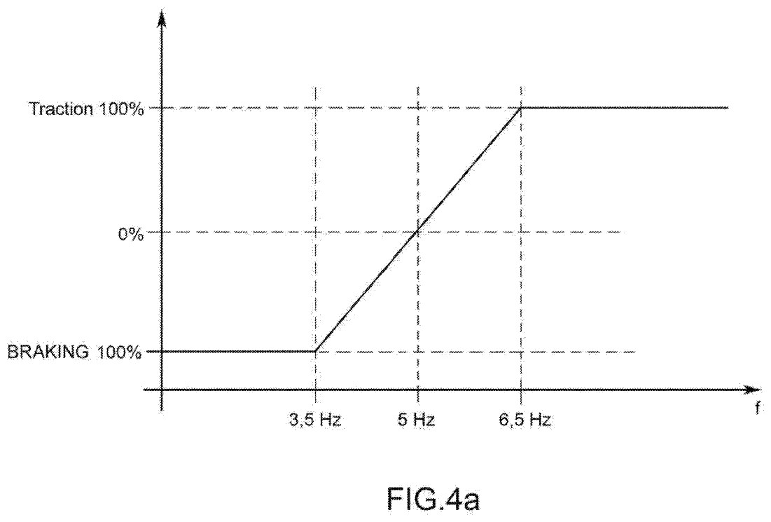

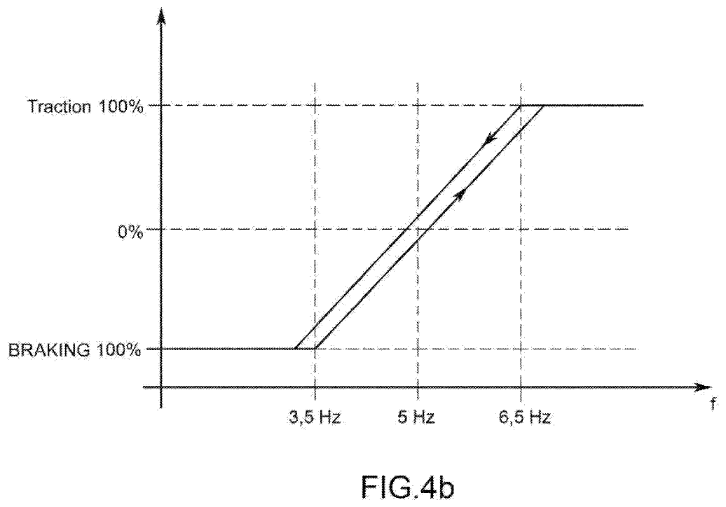

In such case, the most appropriate type of modulation is a modulation of a sinusoidal frequency, for example but not exclusively at 5 Hz, in a limited range of modulation, for example but not exclusively +/−1.5 Hz. Such a limited range of modulation allows in practice to transmit only traction and braking commands, for example but not exclusively as shown in FIG. 4a.

A frequency value equal to or less than 3.5 Hz represents the maximum braking request value, including emergency braking. A frequency value equal to or greater than 6.5 Hz represents the maximum traction request value. A variant is shown in FIG. 4b.

In order to make the system more insensitive to noise, a hysteresis may be inserted the value of which may be fixed or may be changed dynamically by the system according to the noise measured during operation. The curves of FIGS. 4a and 4b have the advantage of guaranteeing the braking request in the case of a no-signal condition, that is, for example, in the case of cutting the pipe. Obviously, other transfer functions may be realized according to the same principle, favoring a precise action in case of loss of the acoustic signal.

In the same way, discontinuous and/or non-linear functions may be achieved, creating areas with lower gain (higher resolution) and areas with greater gain (lower resolution).

Observing FIG. 2, in the case “a” it is possible to see how periodic amplitude peaks may occur when the frequency changes. This phenomenon, as known to those skilled in the art, is caused by the effect of the reflections along the transmission line if the line is properly balanced with said frequencies or not. In order to optimize the transmission frequency, the system may perform a calibration procedure of the central transmission frequency, with the help of the radio system of the “distributed power” system when such system is available. For example, during the initialization phase of the system, the modulator device 303 may perform a slow frequency variation within a predefined range generating respective calibration signals of predetermined amplitude, the frequency demodulators 306 will measure the amplitude trend of the signal received upon variation of the frequency generated by the modulator device 303, identifying the upper peaks. At the end of the procedure, the slave vehicle units SL will transmit each of the frequencies and amplitudes of the peaks detected to the master vehicle unit ML. Subsequently, the modulator device 303 will determine the most appropriate value at which to fix the central modulation frequency, for example, but not exclusively, by choosing the value corresponding to the maximum peak detected by the farthest frequency demodulator 306. At this point, the modulator device 303 will communicate to the various frequency demodulators 306, by means of the radio system, the central frequency value at which it will perform the frequency modulation actions.

The acoustic traction and braking control system for acoustic traction-braking transmission may be used as a backup system to a radio traction-braking transmission system, in case of damage or malfunction of the radio traction-braking transmission system.

An acoustic traction and braking control method is moreover described, which includes the steps of:
receiving at least one traction or braking request signal 302 and generating, by means of a modulator device 303 associated with a master vehicle ML, an electrical signal 308 adapted to energize an actuator 304 provided to transform said electrical signal 308 into a respective acoustic signal 309;
transmitting said acoustic signal 309 in said general brake pipe 301;
adjusting the frequency value of said acoustic signal 309 according to the amplitude value of at least one traction or braking request signal 302, in accordance with a predetermined trans-characteristic function;
detecting, by means of at least one transducer device 305 associated with at least one slave vehicle SL, the acoustic signal 309;
converting, by means of said transducer device 305, the instantaneous amplitude value of the acoustic signal 309 into an electrical signal 310, of which the frequency value is adjusted according to the frequency of the acoustic signal 309;
generating, by means of a frequency demodulator 306 associated with said at least one slave vehicle SL, a traction or braking management signal 307, the amplitude value of which being adjusted according to the frequency of the electrical signal 310; and
transmitting, by means of said frequency demodulator 306, the traction or braking management signal 307 to a traction and braking management system 311 associated with said at least one slave vehicle SL.

Several aspects and embodiments of an acoustic traction and braking control system of a train according to the present invention have been described. It is understood that each embodiment may be combined with any other embodiment. The invention, moreover, is not limited to the described embodiments, but may vary within the scope of protection as described and claimed herein.

1. An acoustic traction and braking control system for a train comprising a general brake pipe, a master vehicle comprising traction and braking devices, and at least one slave vehicle comprising traction and braking devices; said acoustic traction and braking control system including;
a modulator device associated with said master vehicle, which is arranged to receive at least one traction or braking request signal and generate an electrical signal adapted to energize an actuator arranged to transform said electrical signal into a respective acoustic signal to be transmitted within said general brake pipe;
a frequency value of said acoustic signal being adjusted according to an amplitude value of the at least one traction or braking request signal, in accordance with a predetermined trans-characteristic function;
at least one transducer device associated with said at least one slave vehicle, which is adapted to detect the acoustic signal and to convert an instantaneous amplitude value of the acoustic signal into an electrical signal, the frequency value of said electrical si anal being adjusted according to the frequency value of the acoustic signal; and
at least one frequency demodulator associated with said at least one slave vehicle, which is arranged to generate a traction or braking management signal whose amplitude value is adjusted according to the frequency of the electrical signal; the traction or braking management signal being transmitted by the at least one frequency demodulator to a traction and braking management system associated with said at least one slave vehicle, which is arranged for traction and braking management.

2. The acoustic traction and braking control system of claim 1, wherein the frequency value of said acoustic signal corresponds to a braking request value identifying an emergency braking request.

3. The acoustic traction and braking control system of claim 1, wherein a curve of said trans-characteristic function curve comprises a hysteresis.

4. The acoustic traction and braking control system of claim 1, wherein a curve of the trans-characteristic function has a nonlinear behavior within its range of existence.

5. The acoustic traction and braking control system of claim 1, wherein said acoustic traction and braking control system is used as a backup system to a radio traction and braking transmission system.

6. The acoustic traction and braking control system of claim 1, comprising an auto-calibration function capable of detecting and setting a central frequency value in accordance with the maximum value detected by at least one frequency demodulator device arranged to measure an amplitude behavior of the received signal at the varying of the frequency generated by the modulator device.

7. An acoustic traction and braking control method comprising the steps of:
receiving at least one traction or braking request signal and generating, by means of a modulator device associated with a master vehicle, an electrical signal adapted to energize an actuator arranged to transform said electrical signal into a respective acoustic signal;
transmitting said acoustic signal within said a general brake pipe;
adjusting a frequency value of said acoustic signal according to an amplitude value of the traction or braking request signal, in accordance with a predetermined trans-characteristic function;
detecting, by means of a transducer device associated with at least one slave vehicle, the acoustic signal;
converting an instantaneous amplitude value of the acoustic signal into an electrical signal through said transducer device, the frequency value of the electrical signal being adjusted according to the frequency value of the acoustic signal;
generating, by means of a frequency demodulator associated with said at least one slave vehicle, a traction or braking management signal whose amplitude value is adjusted according to the frequency value of the electrical signal; and
transmitting, by means of said frequency demodulator, the traction or braking management signal to a traction and braking management system associated with said at least one slave vehicle.
